(19) United States
(12) Patent Application Publication
(10) Pub. No.: US 2005/0208926 A1
(43) Pub. Date: Sep. 22, 2005

(54) Access point and method for controlling connection among plural networks

(75) Inventor: Masashi Hamada, Setagaya-ku (JP)

Correspondence Address: Canon U.S.A. Inc.;Intellectual Property Department, 15975 Alton Parkway, Irvine, CA, 92618-3731, US

(73) Assignee: Canon Kabushiki Kaisha, Ohta-ku (JP)

(21) Appl. No.: 11/076,365

(22) Filed: Mar. 9, 2005

(30) Foreign Application Priority Data
Mar. 16, 2004 (JP) 2004-074813

(51) Int. Cl. H04M 3/16

(52) U.S. Cl. 455/410; 455/411

(57) ABSTRACT

A wireless access point having a simple configuration provides a network service in accordance with a user level without placing a heavy burden on a user of a client station. The wireless access point controls connections among networks composed of a local network and a backbone network. The local network includes a wireless local network using a wireless communication medium. When establishing a communication association with a wireless station in the wireless local network, the wireless access point monitors a message in a user authentication sequence between the wireless station and an authentication server on a local network so as to acquire the authentication result and predetermined information associated with a login user, and determines a level of the login user. The wireless access point then sets up its own filtering function based on the determination.

### BACKGROUND OF THE INVENTION

1. Field of the Invention

The present invention relates to an access point and a method for controlling connection among a plurality of networks.

2. Description of the Related Art

Recently, in accordance with the widespread use of wireless network systems, such as wireless local area networks (wireless LANs), a wireless network is used as a LAN, and a wireless access point having a filter function has been available in products for controlling a connection with a backbone network.

Additionally, to ensure the security of network access, an extended authentication protocol (EAP) has been introduced to authenticate a user. If the authentication is successful for a wireless station of the user, only the wireless station is authorized to connect to the network.

In order to achieve a seamless connection between a home network and a visited network over an IP (Internet Protocol) network, a method is proposed in which authentication information is transmitted from the visited network to an authentication server in the home network so that validity of a station is checked. In addition, a router of the visited network sniffs an authentication packet in order to search for an optimal route for roaming.

Also, another method is proposed in which a wireless router includes a plurality of wireless communication units whose security levels are different, and a different network service level is assigned to each unit.

However, these known methods have the following drawbacks. That is, since connection control in a visited network is only determined based on a result of a user authentication process, it is difficult to provide a network service on the visited network side in a step-by-step approach.

Also, in the method in which a different network service level is assigned to each wireless communication unit, the number of installations of wireless communication units corresponding to the provided service levels is required. This increases the cost of the wireless access point having a filter function. In addition, an operation for setting a wireless link between wireless communication units having appropriately provided service levels is required, thus placing a heavy burden on a user of a client station.

### SUMMARY OF THE INVENTION

The present invention easily provides a network service in accordance with a user level.

The present invention also provides a network service in accordance with a user level without placing a heavy burden on a user of a client station.

According to the present invention, a method for controlling an access-point includes steps of monitoring a message in a user authentication sequence between a communications station and an authentication server in a first network, acquiring predetermined information and an authentication result associated with a login user from the message monitored in the monitoring step, and setting access parameters for the communications station based on the predetermined information and the authentication result acquired in the acquiring step.

According to the present invention, an access point includes a monitor unit for monitoring a message in a user authentication sequence between a communications station and an authentication server in a first network, an acquiring unit for acquiring predetermined information and an authentication result associated with a login user from the message monitored by the monitor unit, and a setting unit for setting an access limitation for the communications station based on the predetermined information and the authentication result acquired by the acquiring unit.

According to the present invention, a program for controlling an access point includes steps of monitoring a message in a user authentication sequence between a communications station and an authentication server in a first network, acquiring predetermined information and an authentication result associated with a login user from the message monitored in the monitoring step, and setting an access limitation for the communications station based on the predetermined information and the authentication result acquired in the acquiring step.

Further features and advantages of the present invention will become apparent from the following description of exemplary embodiments with reference to the attached drawings.

### BRIEF DESCRIPTION OF THE DRAWINGS

FIG. 1 is a schematic network configuration according to a first embodiment of the present invention.

FIG. 2 is a diagram illustrating functional layers of a wireless access point having a filter function according to the first embodiment of the present invention.

FIG. 3 shows an example of the authentication sequence when a backbone network RADIUS server carries out user authentication in the network configuration according to the first embodiment.

FIG. 4 shows the structure of a RADIUS message data format.

FIG. 5 shows an exemplary structure of attribute information of a RADIUS Access-Request message.

FIG. 6 shows the structure of a network information recording table for every connected client according to the first embodiment.

FIG. 7 shows a flow chart illustrating a basic process to sniff an IP packet sent to a RADIUS server.

FIG. 8 shows a flow chart illustrating a basic process to sniff an IP packet transmitted from a RADIUS server.

FIG. 9 shows a flow chart illustrating a basic update process of the network information recording table for every client.

FIG. 10 shows a flow chart illustrating a basic time-out process of a response delay from the sniffer process of the IP packet sent to the RADIUS server to the sniffer process of the IP packet transmitted from the RADIUS server.

FIG. 11 shows a schematic network configuration according to a second embodiment of the present invention.

FIG. 12 is a diagram illustrating functional layers of a wireless access point having a filter function according to second and third embodiments of the present invention.

FIG. 13 shows an example of an authentication sequence when a backbone network RADIUS server carries out user authentication in the network configuration according to the second embodiment.

FIG. 14 shows the structure of a network information recording table for every connected client according to the second embodiment.

FIG. 15 shows a schematic network configuration according to the third embodiment.

FIG. 16 shows an example of an authentication sequence when a backbone network RADIUS server carries out user authentication in the network configuration according to the third embodiment.

FIG. 17 shows the structure of a network information recording table for every connected client according to the third embodiment.

### DESCRIPTION OF THE EMBODIMENTS

Embodiments of a wireless access point having a filter function, a network system, a method for providing a network service, a computer program, and a recording medium of the present invention will now be described with reference to the accompanying drawings.

### First Embodiment

According to a first embodiment of the present invention, an access point having a filter function is used in a network including a local network and a backbone network. In the local network, an IEEE 802.11 wireless LAN and a Bluetooth network are used as a communication medium for a wireless local network. The operation of the access point will be described below.

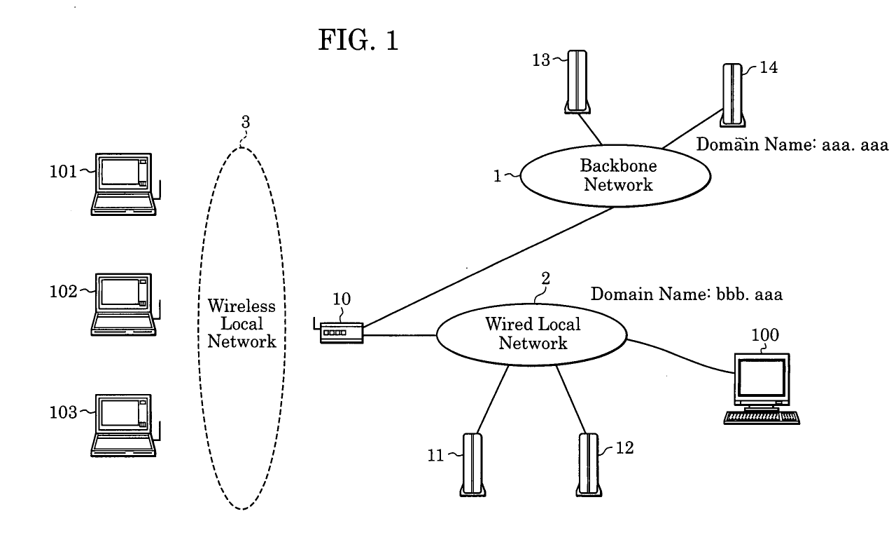

FIG. 1 shows a schematic network configuration according to the embodiment. As shown in FIG. 1, the network configuration includes a backbone network 1, a wired local network 2, a wireless local network 3, a wireless access point 10 having a filter function according to the embodiment, a local network data server 11, a Remote Authentication Dial-In User Service (RADIUS) server 12 having a proxy function for the local network, a backbone network data server 13, a backbone network RADIUS server 14, a wired client station 100, and wireless client station-A 101 to wireless client station-C 103.

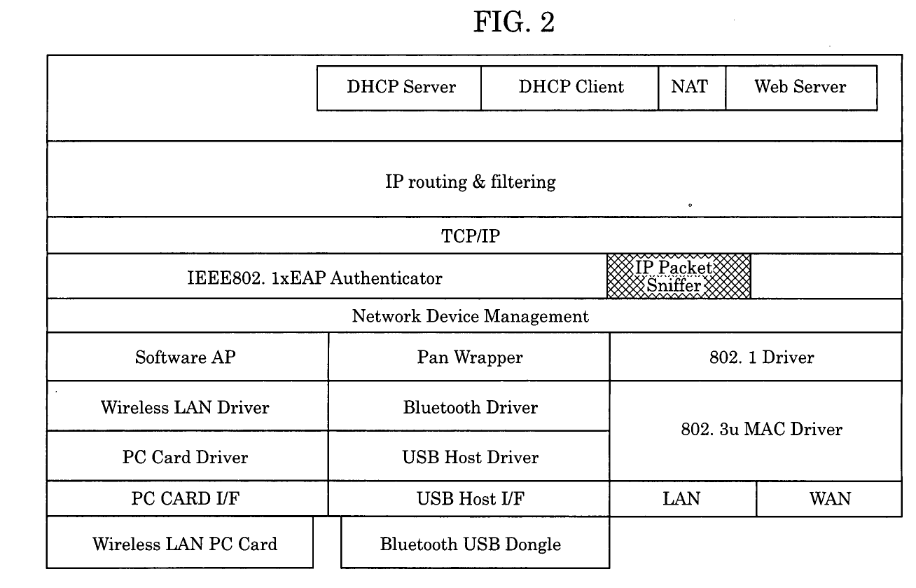

FIG. 2 is a diagram illustrating functional layers in which a control unit (not shown) of the wireless access point 10 having a filter function operates under the control of a program recorded in a memory (not shown). To achieve the wireless access point 10 having a filter function according to the embodiment, an IP packet sniffer functional block monitors the authentication sequence between the local network RADIUS server 12 connected to the wired local network 2 and the wireless access point 10 having a filter function. The following descriptions are based on the control unit of the wireless access point 10 operating under the control of the program recorded in the memory.

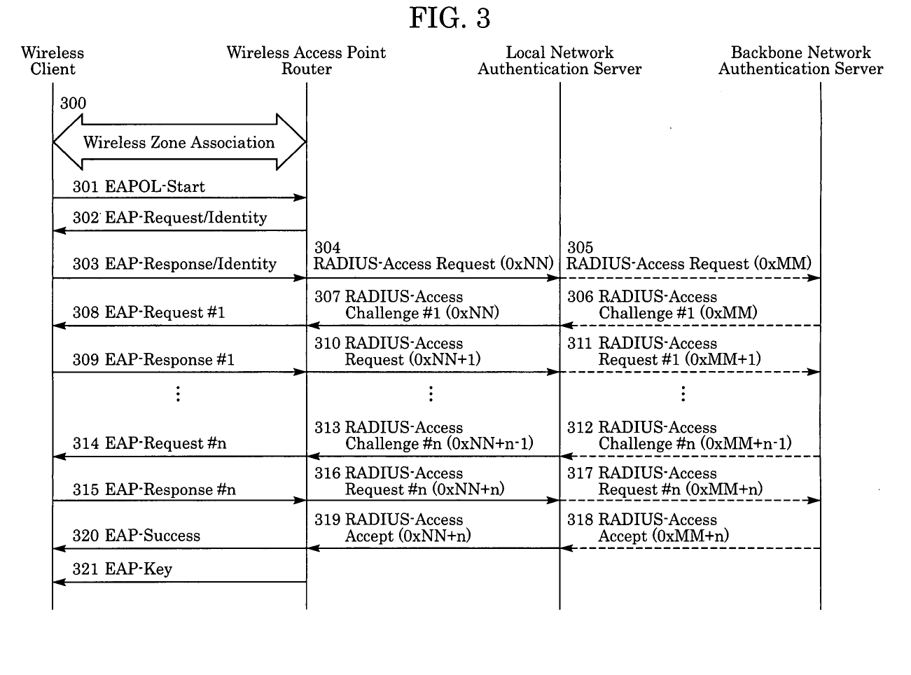

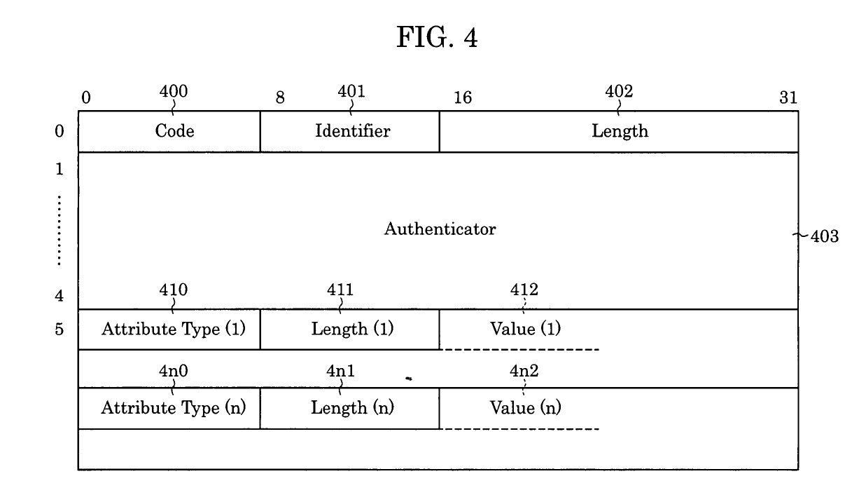

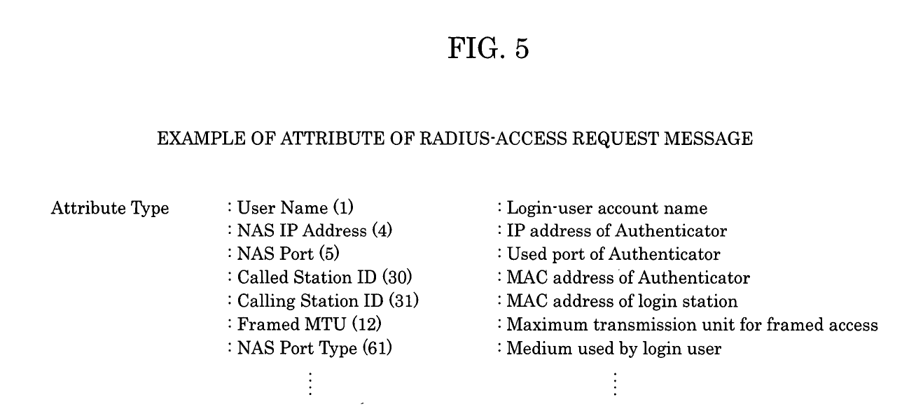

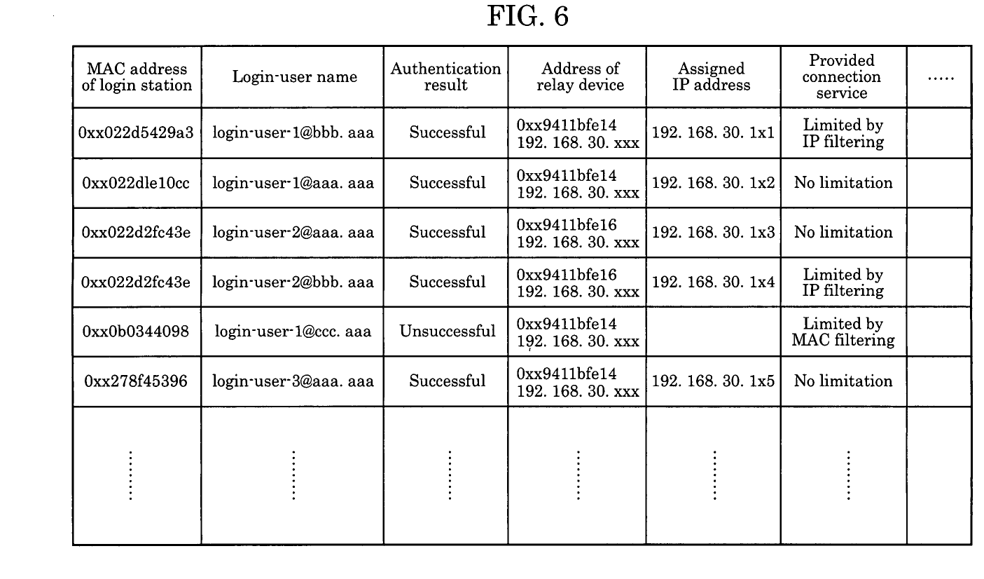

FIG. 3 shows an example of the authentication sequence when the backbone network RADIUS server 14 carries out user authentication in the network configuration shown in FIG. 1. FIG. 4 shows the structure of a RADIUS data format. FIG. 5 shows an example of a structure of attribute information of a RADIUS Access-Request message. FIG. 6 illustrates a network information recording table for every wireless client station. The network information recording table is an example of internal recording that indicates an example of an authentication result for each wireless client station collected by a process according to the embodiment and, in a connected manner, records authentication-related information parameters, such as login user identification information and login wireless station identification information.

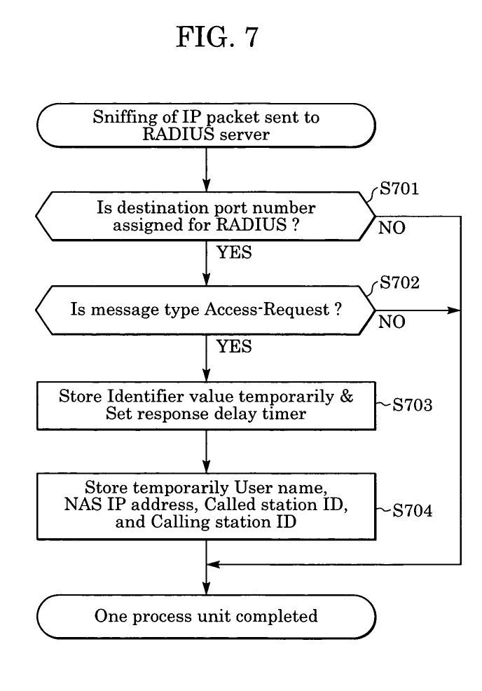

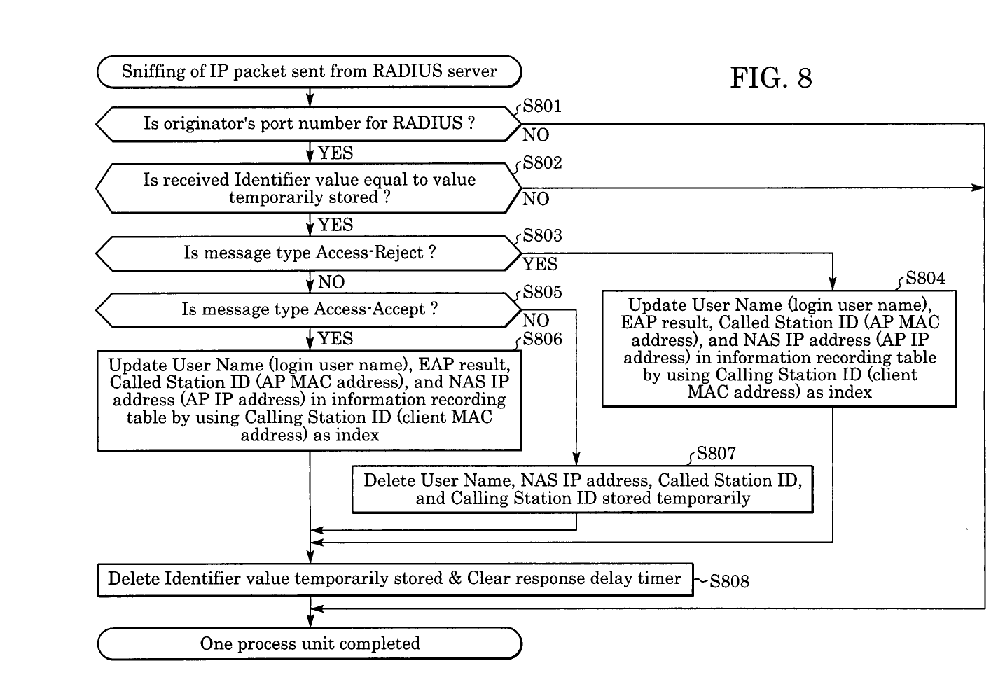

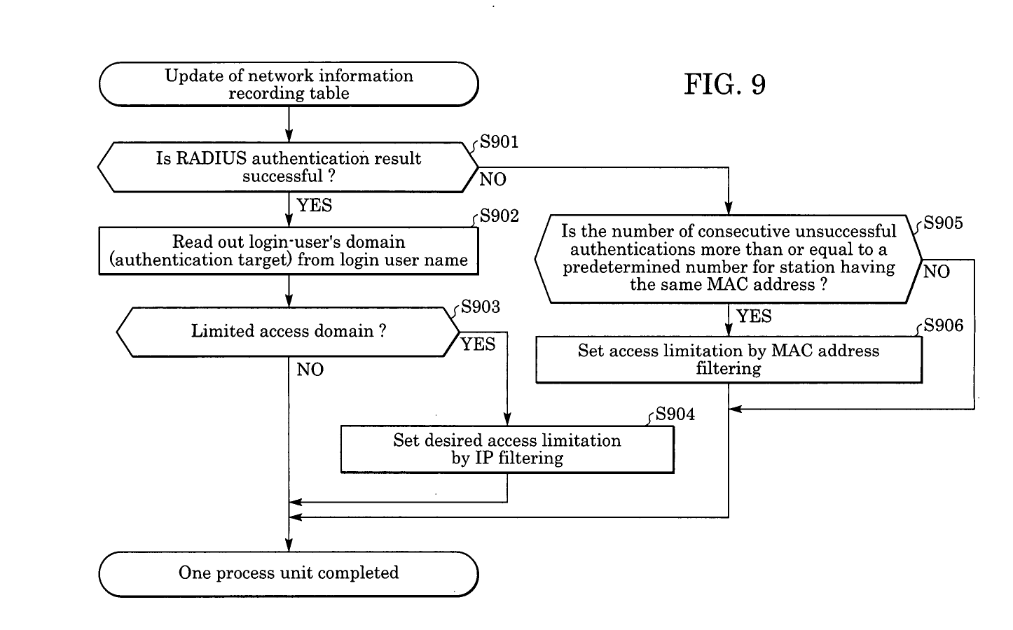

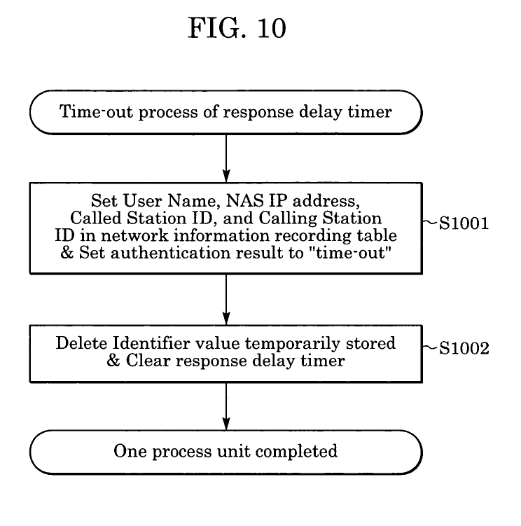

FIG. 7 shows a flow chart illustrating a schematic process to sniff an IP packet sent to a RADIUS server. FIG. 8 shows a flow chart illustrating a schematic process to sniff an IP packet transmitted from a RADIUS server. FIG. 9 shows a flow chart illustrating a schematic update process of the network information recording table for every wireless client station shown in FIG. 6. FIG. 10 shows a flow chart illustrating a schematic time-out process of a response delay from the sniffer process of the IP packet sent to the RADIUS server to the sniffer process of the IP packet transmitted from the RADIUS server.

The schematic update process of the network information recording table for every wireless client station shown in FIG. 6 will be described next with reference to the flow charts shown in FIGS. 7 to 10. An internet protocol (IP) address assigned to the local network RADIUS server 12 is preset in the wireless access point 10 according to the embodiment. An IP packet sent from or to the IP address is identified for sniffing, as shown in FIGS. 7 and 8.

Upon receiving an IP packet sent to the local network RADIUS server 12, the wireless access point 10 compares a TCP port number assigned to the local network RADIUS server 12, which is a number preset in a memory of the access point 10, with a destination port number in the received packet (step S701 in FIG. 7). If the numbers match, then it is determined whether a RADIUS message code 400 is “Access Request” (0x01) (step S702). If not, the process is immediately completed.

If the RADIUS message code 400 is “Access Request” (0x01), the access point 10 temporarily stores the value of “Identifier” 401, which is an identification number of a RADIUS message sequence, in a memory.

Additionally, the access point 10 starts a response delay timer for waiting for a message in response to the message (step S703). The timer is a fixed-interval timer for timing a predetermined time duration. At the same time, the access point 10 temporarily stores in a memory, among information in a RADIUS message attribute 4nn, shown in FIG. 4, of the “Access Request” (0x01) message, a login user name (User Name), an IP address of the authenticator (NAS-IP-Address), a media access control (MAC) address of the authenticator (Called-Station-ID), and a MAC address of the login station (Calling-Station-ID) (step S704). The one process unit is then completed.

In addition, upon receiving an IP packet transmitted from the local network RADIUS server 12, the access point 10 compares the TCP port number assigned to the local network RADIUS server 12, which is a number preset in a memory of the access point 10, with an originator's port number in the received packet (step S801 in FIG. 8). If the numbers do not match, the one process unit is immediately completed. If the numbers match, then it is determined whether the value of “Identifier” 401, which is an identification number of a message sequence of the received packet, is identical to the number temporarily stored at step S703 in FIG. 7 (step S802). If the numbers do not match, the one process unit is immediately completed. If the numbers match, the type of the RADIUS message code 400 in the received packet is checked (steps S803 and S805).

If the type of the RADIUS message code 400 in the received packet is “Access Reject” (0x03) or “Access Accept” (0x02), the access point 10 updates the network information recording table, shown in FIG. 6, for each connected client based on the login user name (User Name), the IP address of the authenticator (NAS-IP-Address), the MAC address of the authenticator (Called-Station-ID), and the MAC address of the login station (Calling-Station-ID) temporarily stored at step S704 of FIG. 7 (steps S804 and S806). The response delay timer is then cleared (step S808) and the one process unit is completed.

If the type of the RADIUS message code 400 is one other than the above-described types, the above-described information temporarily stored is deleted (step S807). Subsequently, the temporarily stored value of “Identifier” 401, which is an identification number of a message sequence of the received packet, is deleted. The response delay timer is then cleared (step S808) and the one process unit is completed.

When the update of the network information recording table, shown in FIG. 6, for each connected client occurs in the above-described RADIUS packet sniffer process, the access point 10 carries out a determination process shown in FIG. 9, for an updated login station, which is managed using a MAC address.

First, the access point 10 determines whether or not the result of the RADIUS authentication is successful (step S901 in FIG. 9). If successful, the access point 10 reads out domain information of a login user (a target of authentication) from the login user name (step S902) and then compares the domain information with restricted-access domain information preset in a memory of the access point 10 (step S903).

If the domain information is not the restricted-access domain information, the access point 10 carries out no access restriction. If the domain information is the restricted-access domain information, the access point 10 sets a restriction condition preset in a memory in a registration table entry of the corresponding login station (in this embodiment, an IP packet is filtered by IP filtering) (step S904). The one process unit is then completed.

If the access point 10 determines that the result of the RADIUS authentication is unsuccessful (step S901), it is then determined whether the number of consecutive unsuccessful authentications is greater than or equal to a predetermined number (step S905). If the number is smaller than the predetermined number, the one process unit is immediately completed. If the number exceeds the predetermined number, the connection of the corresponding station is rejected (in this embodiment, a wireless packet is filtered by MAC filtering) (step S906). The one process unit is then completed.

As shown in FIG. 10, if the response delay timer set at step S703 of FIG. 7 has expired, the access point 10 updates the information including the login user name (User Name), the IP address of the authenticator (NAS-IP-Address), the MAC address of the authenticator (Called-Station-ID), and the MAC address of the login station (Calling-Station-ID), which are temporarily stored at step S704 of FIG. 7, and sets the station as an authentication time-out station (step S1001). Thereafter, the temporarily stored value of “Identifier” 401, which is an identification number of a message sequence of the received packet, is deleted, and the response delay timer is cleared (step S1002). The one process unit is then completed.

Through the above-described process, the access point 10 monitors a message in the user authentication sequence received from and transmitted to the authentication server so as to acquire the authentication result determined before a communication association is established, user identification information for a user authentication, station identification information, and identification information of a wireless unit in the access point that controls a wireless local connection. The access point 10 then stores the information recording table in an automatically generated internal database, in which the identification information of the connected wireless station (i.e., the MAC address in this embodiment) is used as an index.

Thus, every time the information recording table is automatically updated, domain information for each authentication user ID is identified to be authenticated in accordance with the updated information. Accordingly, setting information for IP address filtering, MAC address filtering, a network address translator (NAT) function, an IP masquerade function, and a method for assigning an IP address, corresponding to the domain information can be automatically updated in accordance with the setting condition.

### Second Embodiment

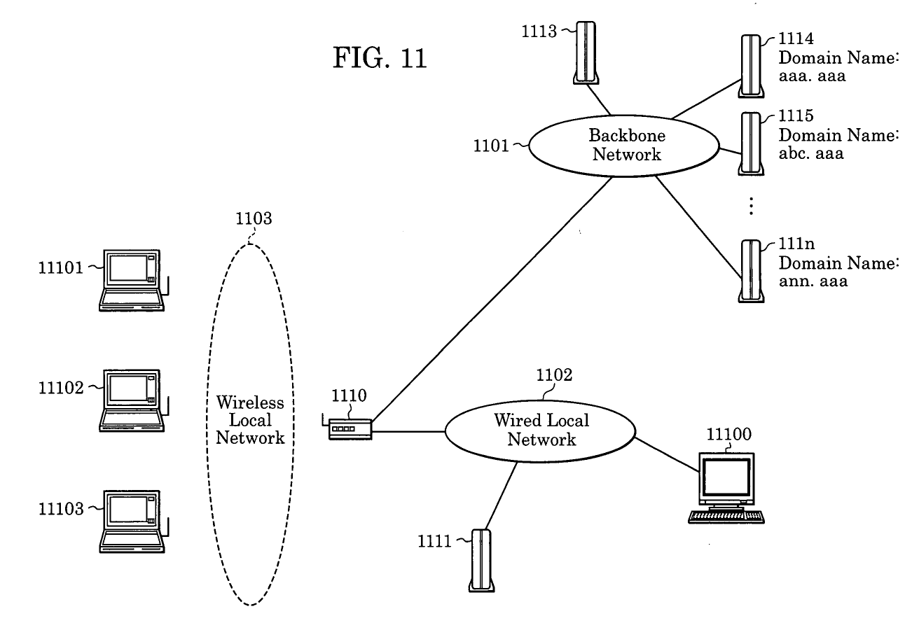

FIG. 11 shows a schematic network configuration according to a second embodiment.

As shown in FIG. 11, the network configuration includes a backbone network 1101, a wired local network 1102, a wireless local network 1103, a wireless access point 1110 having a filter function according to the embodiment, a local network data server 1111, a RADIUS server 1114 having a proxy function in the backbone network (i.e., an authentication server of, for example, an xDSL provider), a backbone network data server 1113, backbone network RADIUS servers 1115 to 111n (i.e., a user authentication server of, for example, an Internet Service Provider (ISP)), a wired client station 11100, and wireless client stations 11101 to 11103.

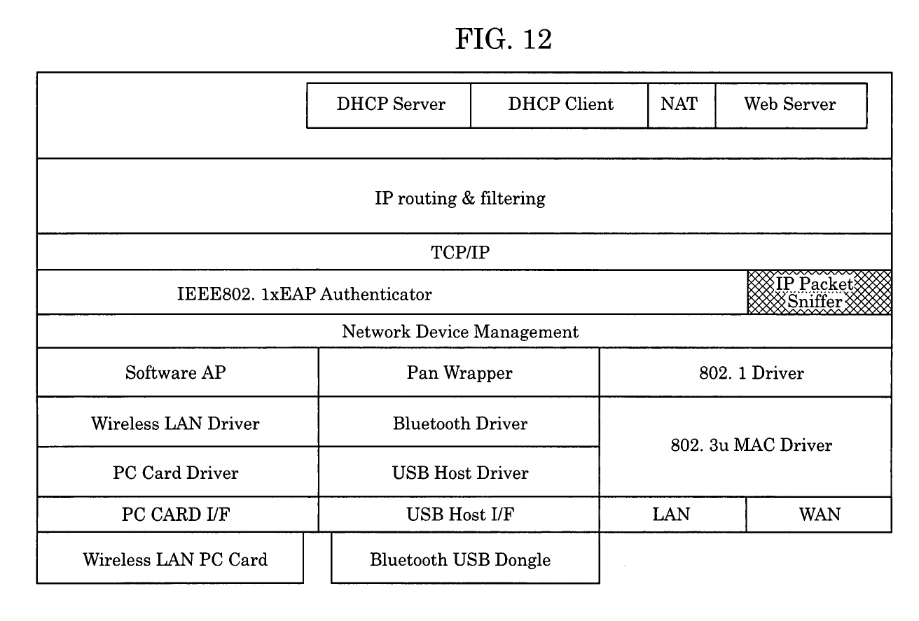

FIG. 12 is a diagram illustrating functional layers of the wireless access point 1110 having a filter function according to the embodiment. To achieve a function according to the embodiment, an IP packet sniffer functional block monitors the authentication sequence between the backbone network RADIUS server 1114 connected to a backbone network interface and the wireless access point 1110 having a filter function according to the embodiment.

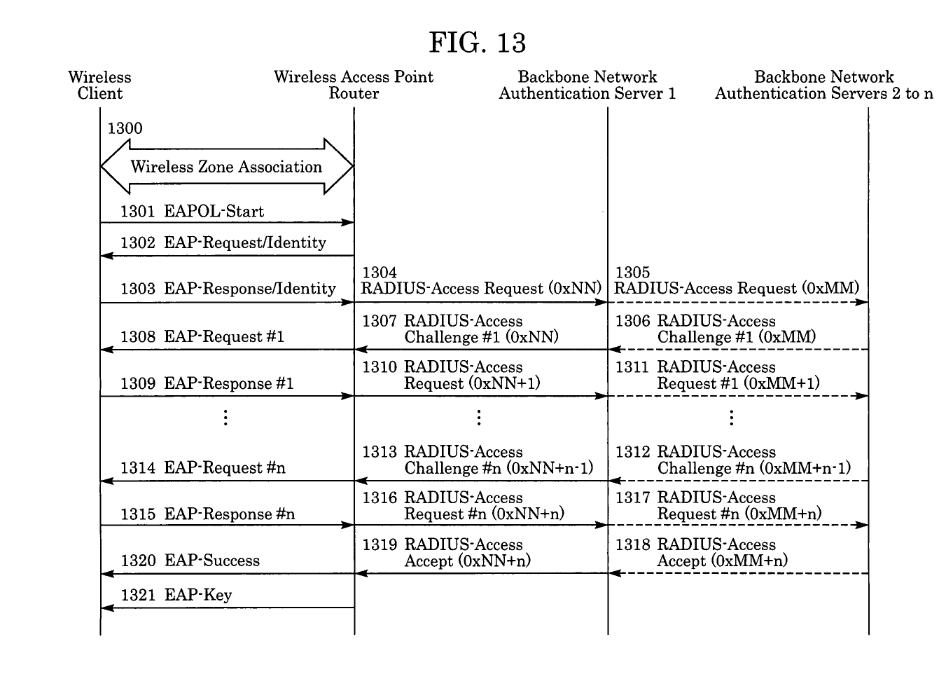

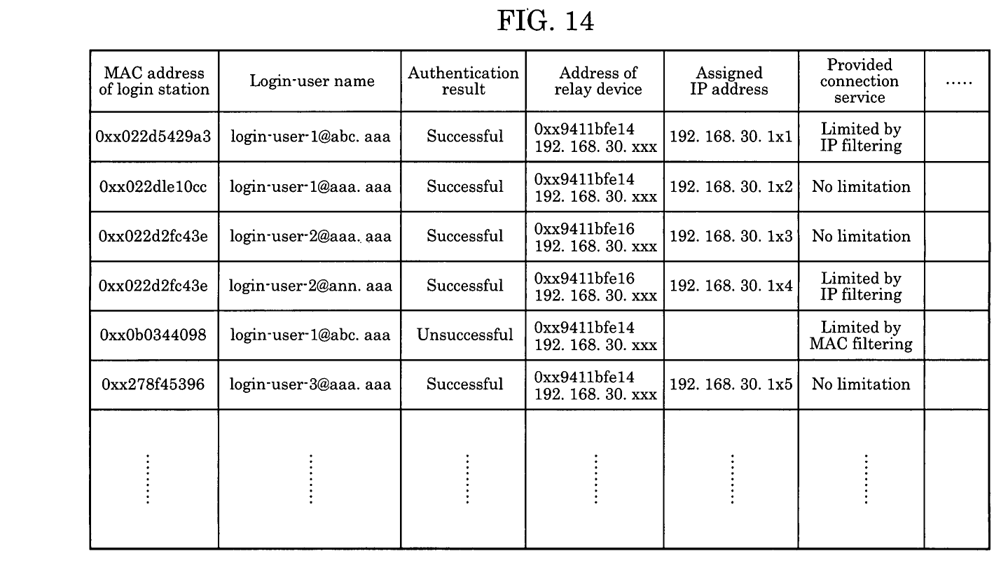

FIG. 13 shows an example of the authentication sequence when the backbone network RADIUS servers 1114 to 111n carry out user authentication in the network configuration shown in FIG. 11. FIG. 14 shows an example of authentication result for each wireless client station collected by a process according to the embodiment. FIG. 14 also shows a network information recording table for every connected wireless client station, which is an example of internal recording that, in a connected manner, records authentication-related information parameters, such as login user identification information and login wireless station identification information.

According to the embodiment, in order to update the network information table shown in FIG. 14, the same method as in the first embodiment (i.e., the method shown by flow charts in FIGS. 7 through 10) is used. The access point 1110 monitors, via a wide area network (WAN) interface, a message in the user authentication sequence received from and transmitted to the authentication server in the backbone network so as to acquire the authentication result determined before a communication association is established, user identification information for a user authentication, station identification information, and identification information of a wireless unit in the access point that controls a wireless local connection. Then, the access point 1110 can store the information recording table in an automatically generated internal database, in which the identification information of the connected wireless station (i.e., the MAC address in this embodiment) is used as an index.

Thus, every time the information recording table is automatically updated, domain information for each authentication user ID is identified to be authenticated in accordance with the updated information. Accordingly, setting information for IP address filtering, MAC address filtering, a NAT function, an IP masquerade function, and a method for assigning an IP address, corresponding to the domain information can be automatically updated in accordance with the setting condition.

### Third Embodiment

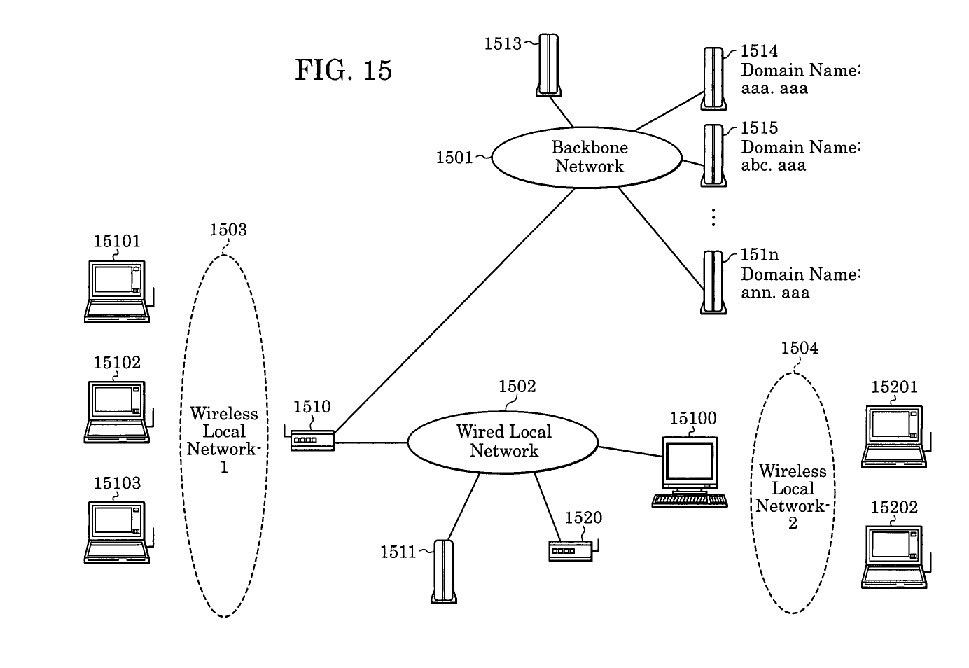

FIG. 15 shows a schematic network configuration according to a third embodiment. As shown in FIG. 15, the network configuration includes a backbone network 1501, a wired local network 1502, a wireless local network-1 1503, a wireless local network-2 1504, a wireless access point 1510 having a filter function according to the embodiment, a local network data server 1511, a RADIUS server-1 1514 having a proxy function for the backbone network (i.e., an authentication server of, for example, an xDSL provider), a backbone network data server 1513, backbone network RADIUS server-2 1515 to RADIUS server-N 151n (i.e., user authentication servers of, for example, an ISP), a wireless access point 1520 having an IEEE 802.1x EAP function, a wired client station 15100, a wireless client station-A 15101, a wireless client station-B 15102, a wireless client station-C 15103, a wireless client station-α 15201, and a wireless client station-β 15202.

In this embodiment, the functional layers of a wireless access point having a filter function, as shown in FIG. 12, is also used, and an IP packet sniffer functional block can monitor the authentication sequence between the backbone network RADIUS server-1 1514 and the wireless access point 1510 having a filter function according to the embodiment, and also can monitor the authentication sequence between the backbone network RADIUS server-1 1514 and the wireless access point 1520, which is connected to the wired local network 1502 and which has a IEEE 802.1x EAP function.

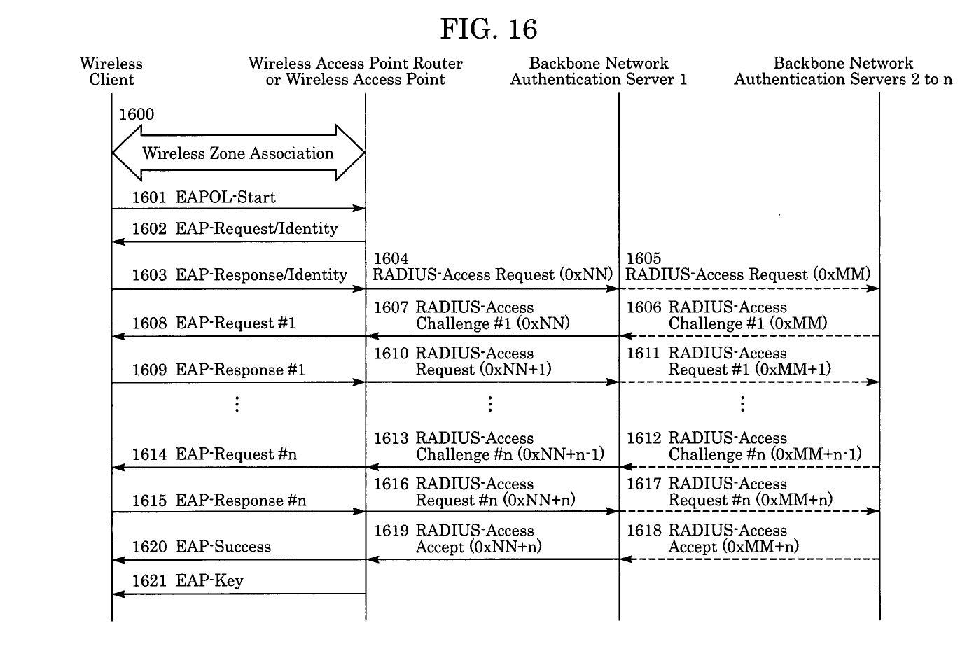

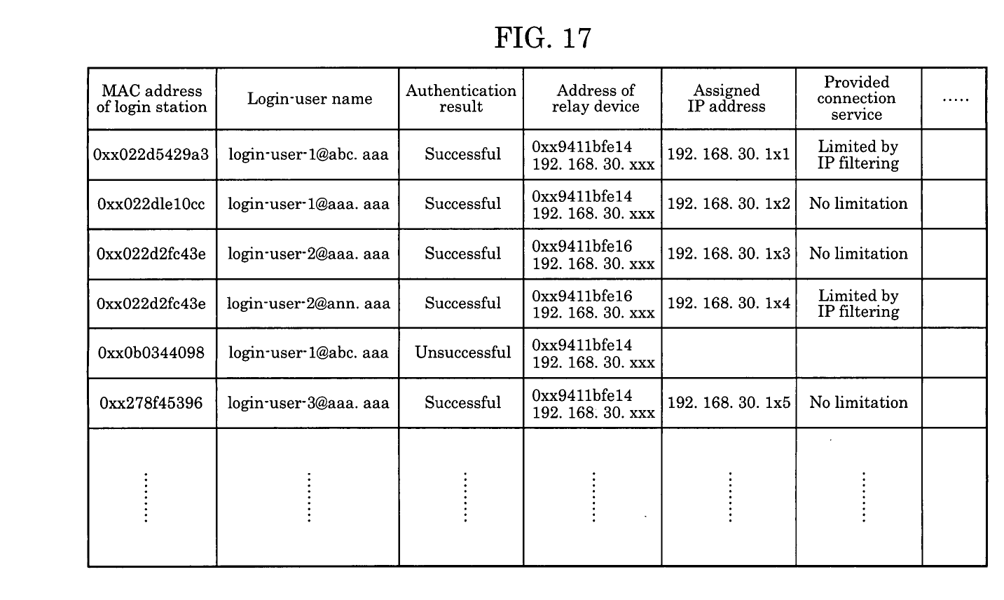

FIG. 16 shows an example of the authentication sequence when the backbone network RADIUS server-1 1514 carries out user authentication in the network configuration shown in FIG. 15. FIG. 17 shows an example of the structure of a network information recording table, which is an internal recording means that, in a connected manner, records an authentication result, login user identification information, login wireless station identification information, and authentication-related information parameters for each wireless client station collected by a process according to the third embodiment.

In this embodiment, the method described in the first embodiment (i.e., the method shown by the flow charts in FIGS. 7 through 10) is also used to update the network information recording table shown in FIG. 17.

Thus, the access point 1510 can monitor, via a WAN interface, messages in the authentication sequence sent from and sent to the authentication server in the backbone network so as to acquire the result of authentication determined before a communication association is established, user identification information for a user authentication, station identification information, and identification information of a wireless unit in the access point that controls a wireless local connection. Then, the access point 1510 can add information about a connection with the wireless access point 1520 connected to the wired local network 1502 to the information recording table and can store the information recording table in an automatically generated internal database, in which the identification information of the connected wireless station (i.e., the MAC address in this embodiment) is used as an index.

Thus, every time the information recording table is automatically updated, one's own domain information to be authenticated is identified for each authentication user ID in accordance with the updated information. Accordingly, setting information for IP address filtering, MAC address filtering, a NAT function, an IP masquerade function, and a method for assigning an IP address, corresponding to the domain information can be automatically updated in accordance with the setting condition.

### Other Embodiments

In the above-described embodiments, an operation of a wireless access point having a filter function is described when the wireless access point uses IEEE 802.11 wireless LAN and a Bluetooth network as a communication medium of a wireless local network and is used in a network system composed of a combination of a backbone network and a local network. However, the communication network medium for a wireless local network is not limited to the above-described medium. The present invention can provide the same advantage in a system which is an IP network including wired and wireless LANs and requires user authentication (an authentication process of an authentication server) before participating in the network.

The present invention includes embodiments in which various types of devices operate so as to achieve the functions of the above-described embodiments by supplying program code of software that achieves such functions to a computer in a system connected to the various types of devices and executing the program stored in the computer (CPU (central processing unit) or MPU (micro-processing unit)) of the system.

In such a case, the program code of the software achieves the functions of the above-described embodiments by itself. That is, the program code itself and means for supplying the program code to the computer, for example, a recording medium storing the program code achieves the present invention. The recording medium for storing the program code includes, for example, a flexible disk, a hard disk, an optical disk, a magneto optical disk, a CD-ROM (compact disk—read-only memory), a magnetic tape, a nonvolatile memory card, and a ROM.

Additionally, in addition to achieving the functions of the above-described embodiments by the computer executing the supplied program, the embodiments of the present invention include the program code that achieves the functions of the above-described embodiments in corporation with an operating system (OS) or other application software running on the computer.

Furthermore, the embodiments of the present invention include the program code that achieves the functions of the above-described embodiments by a process in which, after the supplied program is stored in a memory of an add-on expansion board in the computer or is stored in a memory of an add-on expansion unit connected to the computer, a CPU in the add-on expansion board or in the add-on expansion unit executes some of or all functions of the above-described embodiments.

According to the present invention, messages of a user authentication sequence between a communication station and an authentication server are monitored in a network controlled by an access point before establishing a communication association, and predetermined information associated with a login user is acquired to determine the user level of the login user. Consequently, it can be determined whether the login user is a registered user or a guest user, and therefore, a network service in accordance with the user level can be provided on the fly.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-074813 filed Mar. 16, 2004, which is hereby incorporated by reference herein.

1. A method for controlling an access point, comprising steps of:
monitoring a message in a user authentication sequence between a communications station and an authentication server in a first network;
acquiring predetermined information and an authentication result associated with a login user from the message monitored in the monitoring step; and
setting access parameters for the communications station based on the predetermined information and the authentication result acquired in the acquiring step.

2. The method according to claim 1, wherein the acquiring step further acquires at least one of user identification information for user authentication, identification information of the communications station, and identification information of the access point for controlling a local connection with the communications station.

3. The method according to claim 1, further comprising a step of recording the predetermined information acquired in the acquiring step using identification information of the communications station as an index.

4. The method according to claim 3, wherein the recording step updates the recorded predetermined information at a timing of determining whether or not the user authentication is successful.

5. The method according to claim 3, wherein the recording step updates the recorded predetermined information at an autonomously generated timing.

6. The method according to claim 1, wherein the setting step sets up an access limitation for the communications station.

7. The method according to claim 6, wherein the setting step sets up IP address filtering information for the communications station.

8. The method according to claim 6, wherein the setting step sets up MAC address filtering information for the communications station.

9. An access point comprising:
a monitor unit for monitoring a message in a user authentication sequence between a communications station and an authentication server in a first network;
an acquiring unit for acquiring predetermined information and an authentication result associated with a login user from the message monitored by the monitor unit; and
a setting unit for setting an access limitation for the communications station based on the predetermined information and the authentication result acquired by the acquiring unit.

10. A program for controlling an access point, comprising steps of:
monitoring a message in a user authentication sequence between a communications station and an authentication server in a first network;
acquiring predetermined information and an authentication result associated with a login user from the message monitored in the monitoring step; and
setting an access limitation for the communications station based on the predetermined information and the authentication result acquired in the acquiring step.
